(19) United States
(12) Patent Application Publication
(10) Pub. No.: US 2006/0140704 A1
(43) Pub. Date: Jun. 29, 2006

(54) Letter opener pen

(76) Inventor: Chun Sheng Wang, Young Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/312,749

(22) Filed: Dec. 21, 2005

(30) Foreign Application Priority Data
Dec. 27, 2004 (TW) 093220948

(51) Int. Cl. B43K 29/00

(52) U.S. Cl. 401/195

(57) ABSTRACT

A letter opener pen includes a pen barrel, a cap removably attached to the barrel, a clip mounted to the clip, and an U-shaped resilient leaf arranged between the cap and clip to serve as a paper-cutting device. The resilient leaf is of a U-shape having two legs attached to the cap and the clip, respectively. The legs have opposite ends defining a U-shaped opening facing upward, which induces a spring force to bias a lower end of the clip against the cap to provide the clip with a gripping force that secures the pen to for example a pocket. The end of one leg of the U-shape is bent to form a cutting edge, which can be used to cut or trim a piece of paper or to unseal an envelop by placing the piece of paper of the envelop in the U-shaped opening and applying a pressure to the clip to press the cutting edge against the paper or envelop.

### BACKGROUND OF THE INVENTION

1. Field of the Invention

The present invention generally relates to a combination of letter opener and writing instrument, and specifically to a the pen with cap, connected to clip by a resilient slice, and easy to use in writing-and-drawing, opening letters or cutting paper aspects.

2. The Related Arts

Most pens, whether capped or uncapped, are equipped with a clip in the cap or the barrel to enable the pen to be attached to a shirt pocket or briefcase for easy carrying. This kind of clip-pens offers no extra function but a holding mechanism only.

In addition, people use pen to write or draw as their regular function among all sorts of stationery. When it comes to any occasion that a person needs to cut papers, such as opening a letter, the person must use another instrument, such as a letter opener and a pair of scissors. However, using two instruments is subject to limitation and is inconvenient.

If the use of common pens can be broadened by being combined wit the function of letter opening to meet both needs, then the practicability and convenience of regular pens can be enhanced. However, there is not yet any design available on the market can fit in these requirements.

### SUMMARY OF THE INVENTION

The present invention provides a pen with letter-opening function, which specifically refers to a letter opener pen, comprising a U-shaped resilient leaf arranged between a cap and a clip of the pen or alternatively between a barrel and a clip of an uncapped pen. The resilient leaf has two legs attached to the clip and the cap (or barrel) of the pen and defining an upward-facing opening. One of the legs forms a sharp cutting edge for easily cutting a piece of paper or unsealing an envelope.

Thus, the present invention provides a letter-opening pen featuring both regular writing-and-drawing and paper-cutting functions.

A primary objective of the invention is, therefore, to provide a letter opener pen comprising of a U-shaped resilient leaf formed between a cap and a clip or the pen or alternatively between a barrel and a clip of an uncapped pen, a leg of the U-shaped leaf, preferably the one attached to the cap or the barrel, forming at a tip end thereof a cutting edge by which a user may easily cut a piece of paper or unsealing an envelope.

In order to fulfill the objective, the present invention provides a letter opener pen comprising a barrel, a cap, a clip, and a resilient leaf arranged between the cap and the clip.

The resilient leaf is of a U-shape having two legs attached to the cap and the clip, respectively. The legs are arranged to form an upward-facing opening of the U-shape, which induces an outward spring force to bias a lower end of the clip against the cap and thus providing the clip with a gripping force.

The resilient leaf, which has two legs forming a U-shaped opening therebetween, is bent at an end of one leg, which is provided with a sharp edge and serves as a cutting edge. A user can use the U-shaped opening and the cutting edge to cut a piece of paper or unseal an envelope.

The U-shaped leaf, which is of a simple construction, is provided between the cap and the clip and thus occupying no additional space and increases very limited amount of weight.

In practical manufacturing, the U-shaped resilient leaf can be positioned between the cap and the clip of a pen to bundle with capped pen, or alternatively, it can be positioned between the clip and the barrel of an uncapped pen.

The cutting edge of the U-shaped resilient leaf in accordance with the present invention is actually hidden in the U-shaped opening of the resilient leaf, so that the cutting edge does contact and hurt any portion of the user's body and causes no harm to other articles, such as a shirt pocket or a briefcase to which the pen is attached with the clip. Thus, the pen is safe to regular consumers or even young children.

The present invention makes the pen better meet with regular writing-and-drawing function and paper cutting ability to add its practical value.

### BRIEF DESCRIPTION OF THE DRAWINGS

In order to clearly show and make better comprehension of these and other features and advantages of the present invention, the present invention will now be described by way of example, with reference to a specific embodiment illustrated in the drawings, in which:

FIG. 1 shows a perspective view of a letter opener pen according to a preferred embodiment of the present invention;

FIG. 2 shows an exploded view of the letter opener pen according to the present invention;

FIG. 3 shows a side elevational view of the letter opener pen according to the present invention; and

FIG. 4 is a perspective view showing an application of the letter opener pen of the present invention to cut a piece of paper.

### DETAILED DESCRIPTION OF THE PREFERRED EMBODIMENT

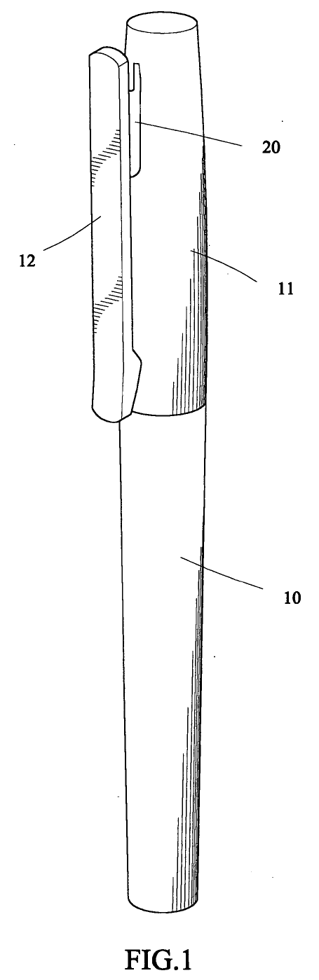

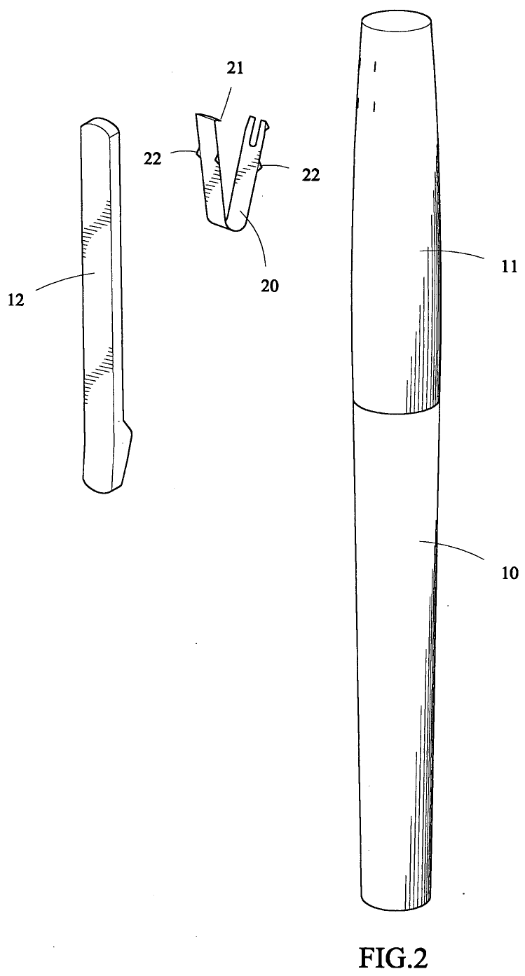

With reference to the drawings and in particular to FIGS. 1 and 2, which show, respectively, a perspective view and an exploded view of a letter opener pen constructed in accordance with a preferred embodiment of the present invention, the letter opener pen of the present invention comprises a barrel 10, a cap 11, a clip 12, and a resilient leaf 20 positioned between the cap 11 and clip 12.

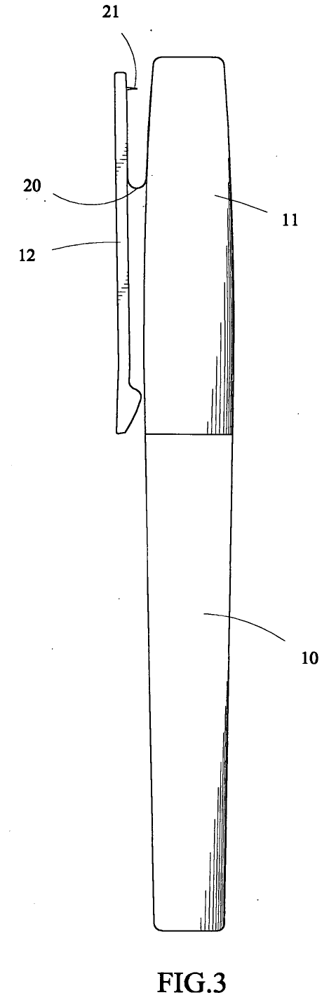

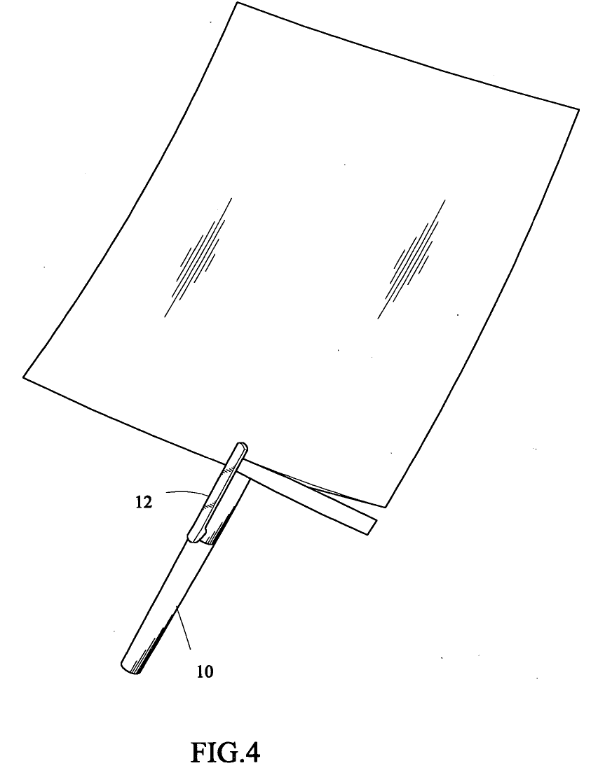

Also referring to FIGS. 3 and 4, which shows a sides plan view of the letter opener pen of the present invention and an application of the letter opener pen, respectively, the resilient leaf 20 is of a U-shape having two legs attached to the cap 11 and the clip 12, respectively. The legs define a U-shaped opening, which is facing upward. The U-shaped opening induces an outward spring force that biases a lower end of the clip 12 against the cap 11 and thus providing the clip 12 with a gripping force to fix to an external article, such as a shirt pocket.

The resilient leaf 20 that defines a U-shaped opening with the legs thereof forms a bending at a tip end of the leg attached to the clip 12. The bending has a sharp free end that serves as a cutting edge 21. The outward spring force of resilient leaf 20 and the cutting edge 21 allows a user to cut a piece of paper or to unseal an envelope by placing the piece of paper or envelop in the U-shaped opening and applying a pressure on the clip 12 against the spring force of the U-shaped opening while moving the paper or envelope as shown in FIG. 4.

The legs of the resilient U-shaped leaf 20 can be attached to the cap 11 and the clip 12 by any known means, such as ultrasonic welding. Preferably, the legs of the resilient leaf 20 are provided with triangular biter 22 that help secure the legs to the clip 12 and the cap 11.

Although in the embodiment of the letter opener pen illustrated in FIGS. 1-3 illustrate a capped pen, yet the present invention is applicable to an uncapped pen by attaching the legs of the U-shaped resilient leaf 20 to the clip 12 and the barrel 10 of the pen, respectively.

As the above stated, it is easy to understand that the feature of the invention lies in a resilient leaf, which is embodied and positioned between a cap and a clip of a pen or between a barrel and a clip of a pen, having an U-shaped opening and a cutting edge formed at a tip end of the leg of the U-shaped leaf that is attached to the clip. The U-shaped opening and the cutting edge of the resilient leaf can be used to easily cut or trim a piece of paper or to unseal an envelop, whereby the pen is provided with both regular writing-and-drawing mechanism and letter-opening mechanism to achieve the propose that the invention intends to realize.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A letter opener pen comprising a writing instrument having a body to which a clip is mounted, and a U-shaped resilient leaf arranged between the body and the clip, wherein the leaf comprises two legs attached to the body and the clip respectively, the legs having opposite ends defining a U-shaped opening, the end of one of the leg forming a bent sharp edge serving as a cutting edge.

2. The letter opener pen as claimed in claim 1, wherein the legs of the resilient leaf are selectively provided with triangular bites for securing the legs to the body and the clip.

3. The letter opener pen as claimed in claim 1, wherein the writing instrument comprises a pen and the body comprises a barrel and wherein the clip is mounted to the barrel and the U-shaped resilient leaf is fixed and positioned between the barrel and the clip.

4. The letter opener pen as claimed in claim 1, wherein the writing instrument comprises a pen having a barrel and the body comprises a cap removably attached to the barrel and wherein the clip is mounted to the cap and the U-shaped resilient leaf is fixed and positioned between the cap and the clip.
